(19) United States
(12) Patent Application Publication
(10) Pub. No.: US 2010/0306226 A1
(43) Pub. Date: Dec. 2, 2010

(54) Electronic Advertisement System

(75) Inventors: Aleem R. Mawani, Markham (CA); Adam Isaac Juda, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/552,636

(22) Filed: Sep. 2, 2009

Related U.S. Application Data
(60) Provisional application No. 61/182,170, filed on May 29, 2009.

(51) Int. Cl. G06F 17/30

(52) U.S. Cl. 707/759; 707/769; 707/765

(57) ABSTRACT

A keyword, first online query volume information for the keyword in a first geographic region, and second online query volume information for the keyword in a second geographic region are received. A first parameter is calculated based on the first online query volume information and the second online query volume information, and the first parameter is determined to satisfy a threshold. In response to the determination that the first parameter satisfies the threshold, a first medium distributed in the first geographic region is identified and an item including the keyword is forwarded for placement in the first medium. Revenue generated by placement of the item in the first medium is determined.

### CROSS REFERENCE TO RELATED APPLICATION

This application claims priority to U.S. Provisional Application No. 61/182,170, which was filed on May 29, 2009, is titled “AN ELECTRONIC ADVERTISEMENT SYSTEM,” and is incorporated by reference in its entirety.

### TECHNICAL FIELD

The following disclosure relates to selecting media and placing advertisements of an appropriate type in the media.

### BACKGROUND

Content of different types may be placed in media. For example, advertisers provide advertisements (“ads”) in different forms in order to attract consumers. Types of ads include online ads that can be provided as banner advertisements on a web page, or an ad in a web page that can be presented, for example, in response to one or more keywords in a user search query input to a search engine. If a user selects the presented ad, the user is generally taken to another location associated with the ad, such as, for example, to an associated web page.

Offline electronic ads (e.g., commercials) can be provided with content in, for example, compact disks, electronic publications, and electronic billboards (e.g., in elevators, airports, and along roadways). Advertisers can submit a print ad to a publisher for inclusion in one or more printed publications, such as newspapers or magazines, for a price specified by the publisher. The advertisers typically also specify the placement of the print ad in the printed publication, including parameters such as the edition in which the print ad is to appear, the page on which the print ad is to run, and the size of the print ad.

### SUMMARY

An automated, scalable advertisement system may be implemented to manage content placement requests. The advertisement system may be implemented as an online, e.g., web-based, advertisement system, such as an online search engine that also provides advertisements. The advertisement system may include at least one processor connected to at least one storage device.

In one aspect, a keyword, first online query volume information for the keyword in a first geographic region, and second online query volume information for the keyword in a second geographic region are received. A first parameter is calculated based on the first online query volume information and the second online query volume information, and the first parameter is determined to satisfy a threshold. In response to the determination that the first parameter satisfies the threshold, a first medium distributed in the first geographic region is identified and an item including the keyword is forwarded for placement in the first medium. Revenue generated by placement of the item in the first medium is determined.

Implementations may include one or more of the following features. For example, the item may be an advertisement, and receiving the keyword may include determining whether revenue generated by the keyword for a particular number of impressions is greater than a predetermined threshold.

Receiving the first online query volume information for the keyword in the first geographic region may include receiving a first number of times the keyword was included in online search queries originating from the first geographic region, and receiving the second online query volume information for the keyword in the second geographic region may include receiving a second number of times the keyword was included in online search queries originating from the second geographic region. Determinations may be made that the first number of times the keyword was included in online search queries originating from the first geographic region satisfies a predetermined threshold, and that the second number of times the keyword was included in online search queries originating from the second geographic region satisfies the predetermined threshold.

Determining the revenue generated by placement of the item in the first medium may include determining an actual number of online search queries including the keyword originating from the first geographic region over a predetermined time period after the item has been placed in the first medium, determining an actual number of online search queries including the keyword originating from the second geographic region over the predetermined time period after the item has been placed in the first medium, and determining, based on the actual number of online search queries including the keyword originating from the second geographic region, a predicted number of online search queries including the keyword originating from the first geographic region over the predetermined time period if the item had not been placed in the first medium. The difference between the actual number and the predicted number of online search queries including the keyword originating from the first geographic region may be calculated to determine an additional number of online search queries, and, based on the additional number of online search queries, the revenue generated by placement of the item in the first medium may be determined. Determining, based on the additional number of online search queries, the revenue generated by placement of the item in the first medium may include receiving an average amount of revenue generated by the keyword for a particular number of impressions, and multiplying the additional number of online search queries by the average amount of revenue generated by the keyword for a particular number of impressions.

Whether the item placement was effective may be determined by determining a cost associated with placement of the item in the first medium, determining that the revenue generated by placement of the item in the first medium is greater than the cost associated with placement of the item in the first medium, and determining, based on the determination that the revenue generated by placement of the item in the first medium is greater than the cost associated with placement of the item in the first medium, that the item placement was effective.

One or more additional keywords may be determined and forwarding the item including the keyword for placement in the first medium may include forwarding an item including the keyword and the one or more additional keywords for placement in the first medium.

The first geographic region and the second geographic region may overlap by less than a predetermined threshold.

Forwarding the item including the keyword for placement in the first medium may include generating the item including the keyword using existing online information.

Details of one or more implementations are set forth in the accompanying drawings and the description below. Other aspects can be implemented in systems and computers and will be apparent from the description and drawings, and from the claims.

### DESCRIPTION OF DRAWINGS

FIG. 1 is a flowchart showing an example process for selecting publications and placing print ads in the selected publications.

FIG. 2 is a flowchart showing an example process for processing query volume information and selecting a publication to place a print ad.

FIG. 3 shows example geographic regions and publication distribution regions.

FIG. 4 shows an example chart of query volume for one identified keyword in two distribution regions over time.

FIG. 5 is a flowchart showing an example process for analyzing the effectiveness of a print ad.

FIG. 6 shows an example print ad placed in a publication.

FIG 7 is a block diagram of an example electronic advertisement system.

FIG. 8 is a block diagram of a computer system.

Like reference symbols indicate like elements throughout the specification and drawings.

### DETAILED DESCRIPTION

Techniques, methods, apparatus, computer program products, and systems for content presentation (e.g., advertising) are described that can be used to facilitate print publication. Reference will be made herein to publication of ads, though publication of other forms of content items are possible. Print advertising as used herein refers to advertising occurring in print media, such as newspapers, magazines, journals, periodicals, flyers, brochures, and other printed publications. An ad placed in a printed publication shall be referred to herein as a “print ad.” While the discussion below makes reference to print ads for ease of illustration, the systems and methods disclosed herein can be applied to other forms of sponsored content, such as online ads, radio ads, and television ads.

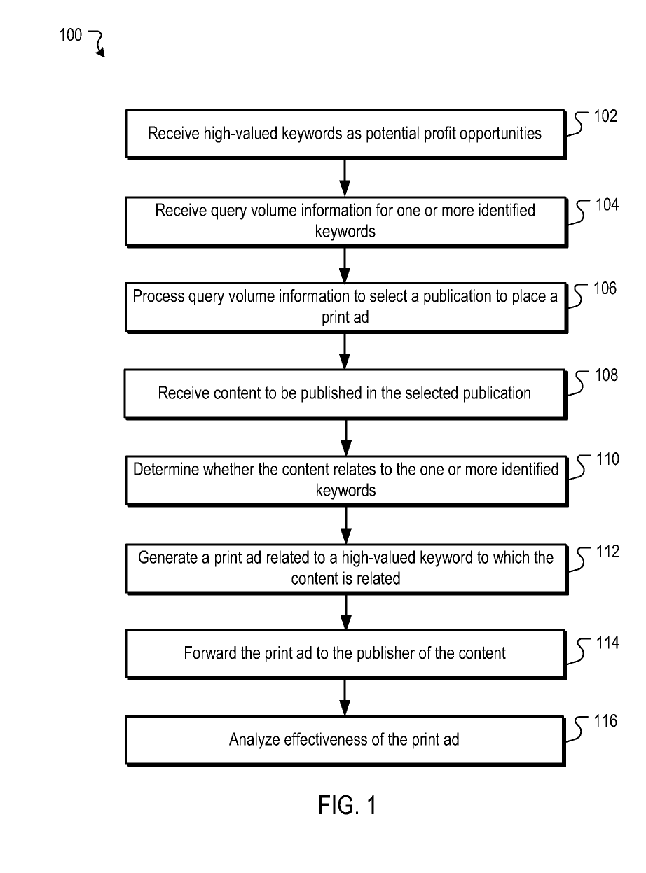

FIG. 1 is a flowchart showing an example process 100 for selecting publications and placing print ads in the selected publications. One or more steps in the process 100 can be carried out by, for example, an electronic system (e.g., an electronic advertisement system or search engine). The system receives and/or selects high-valued keywords, e.g., search terms, as potential profit opportunities (step 102). For example, the system can select the top performing keywords as high-valued keywords. In some implementations, the top performing keywords may be those that generate more than a threshold amount of revenue for the electronic advertisement system for a particular number of deliveries, e.g., impressions, such as 1000 impressions.

Revenue can be generated by a keyword when an ad associated with the keyword is delivered and/or when an ad associated with the keyword is selected, e.g., clicked on, by a user. The revenue generated by the keyword based on delivery of the ad can be determined by multiplying the number of impressions of the ad by an amount paid by an advertiser for each impression. The revenue generated by the keyword based on selection of the ad can be determined by multiplying the click-through rate for the ad by the amount paid by an advertiser when an ad is selected.

The click-through rate can be a performance metric that is obtained by dividing the number of users that clicked on an ad or a link associated with the ad by the number of times the advertisement was delivered. For example, if an ad is delivered 1000 times and 30 users clicked on the ad, then the click-through rate for that ad is 3%. The click-through rate for all ads associated with the keyword can be aggregated to determine the click-through rate for the keyword.

Other performance metrics can also be used. The performance metrics can, for example, be revenue related or non-revenue related. In some implementations, the performance metrics can be parsed according to time, e.g., the performance of a keyword may be determined to be very high on weekends, moderate on weekday evenings, and very low on weekday mornings and afternoons.

The system then receives query volume information for one or more of the identified keywords (step 104). In some implementations, the query volume information includes the number of times each identified keyword was used as part of a search query. In other implementations, the query volume information can include the number of times each identified keyword was included in retrieved content.

The query volume information also includes geographic information. The geographic information includes the location from which a search query including one of more of the identified high-valued keywords originated and/or the location from which the content including one or more of the identified high-valued keywords was requested. The format of the geographic information may take a variety of forms, including full addresses, city and state names, zip codes, metropolitan areas, and latitude/longitude pairs. The geographic information may be obtained using standard techniques, such as by accessing GPS information through associated with a device that generated the query, or based on an IP address from which the search query originated.

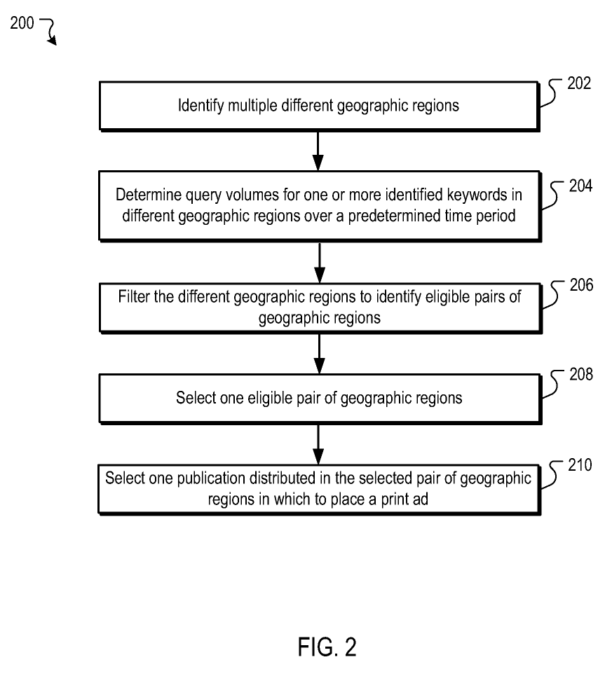

The received query volume information is processed by the system to select a publication in which to place a print ad (step 106). As discussed in greater detail below in connection with FIG. 2, the system uses the query volume information to identify a publication distributed in a particular geographic region for placement of a print ad.

In some implementations, once the publication in which to place the print ad is selected, the print ad is generated (step 112) and forwarded to the publisher (step 114). In some implementations, once a publication is selected, content to be published in the selected publication is received by the system (step 108) before the content is published. The term “content” refers to various types of print-based information, such as, for example, articles, classified ads, reports, analyses, and financial statements. In some implementations, the content may be received directly from the publisher of the selected publication. In other implementations, the content may be received from a third party that provides the publisher with the content. For example, a newsgathering organization may provide the publisher of a regional newspaper with content to publish in the newspaper. In this example, the system may receive the content from the newsgathering organization or from the publisher.

The system then determines whether the content relates to the one or more of the identified keywords (step 110). The content is analyzed to determine the “context” of the content (e.g., the topic) to determine whether any of the one or more of the identified keywords matches the context. In some implementations, if more than one of the identified keywords is determined to match the context of the content, then the best-matching keyword is selected. In other implementations, more than one of the identified keywords that are determined to match the context of the content can be selected.

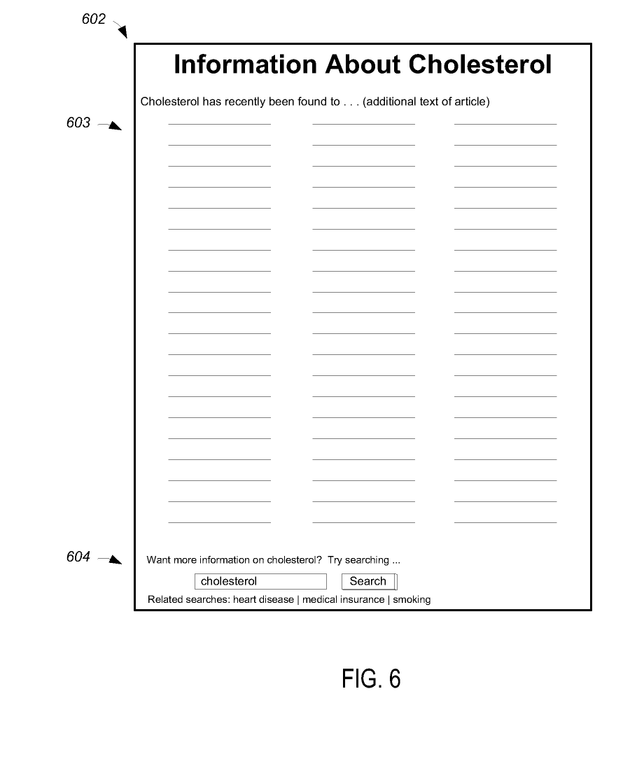

If one or more of the identified keywords are determined to relate to the content, a print ad that is related to the selected keywords is generated by the system (step 112). The print ad can include a search box including the selected keywords to encourage a reader of the publication to search for the keywords. In some implementations, the print ad can also suggest other keywords to be used as a search term. For example, if more than one identified keyword is determined to match the context of the content and only one of the keywords is included in the search box, then at least one of the remaining keywords can be suggested. In another example, the system can use an internal database to select keywords that are related to the identified keyword included in the search box. The keywords from the internal database may or may not be high-valued. An example of a generated print ad is shown in FIG. 6.

The size of the generated print ad can be a predetermined size. The size of the print ad may be defined by a fraction of a page, number of columns, and/or unit of measurements, such as inches or centimeters. Examples of suitable sizes for the print ad may include 1 column by 1 inch, 1 column by 3.5 inches, 2 columns by 1 inch, or ¼ page. The predetermined size of the print ad can be different depending on the type of publication. For example, the size of the print ad can be 1 column by 1 inch if the publication is a newspaper, or the size of the print ad can be ¼ page if the publication is a magazine.

Once the print ad is generated, the print ad is forwarded to the publisher for placement in the selected publication (step 114). In some implementations, the print ad can be placed in any available slot in the selected publication. In other implementations, the print ad can be published in or near the content in the selected publication. For example, if the content is an article, the print ad can be published within a border surrounding the article or adjacent to the border surrounding the article. In another example, if the content is a full-page article, the print ad can be published on a page adjacent to the full-page article.

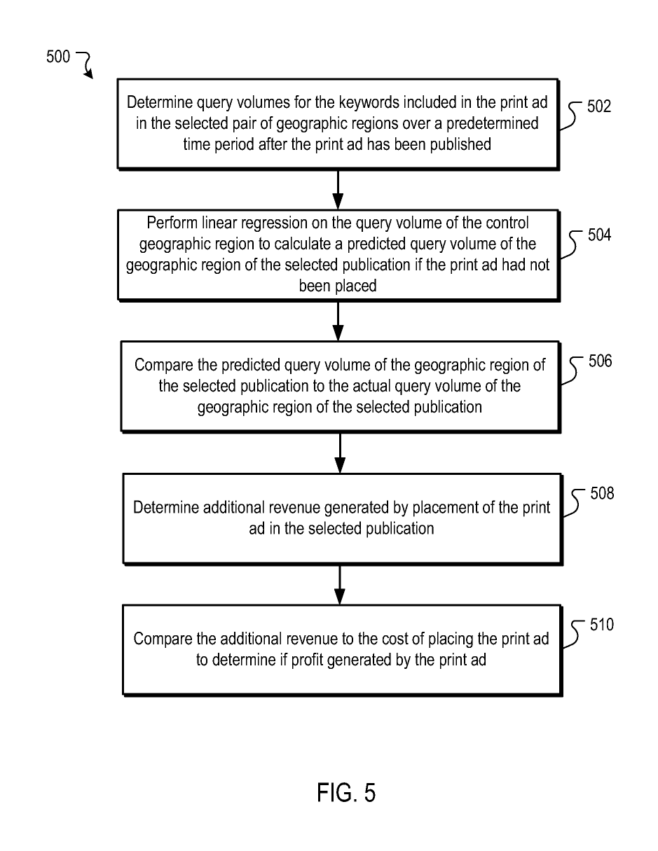

After the print ad has been forwarded and published, the effectiveness of the print ad may be analyzed (step 116). To analyze the effectiveness of the print ad, the system determines whether the print ad generated additional revenue for the selected keywords. If the additional revenue is generated and is greater than the cost associated with placing the print ad in the selected publication, then profit is generated by placement of the print ad. In some implementations, analyzing the effectiveness of the print ad can include evaluating the advertiser's sales based on traffic generated by the print ad. The analysis performed by the system to determine the additional revenue for the selected keywords is described below in greater detail in connection with FIG. 5.

FIG. 2 is a flowchart showing an example process 200 for processing query volume information and selecting a publication in which to place a print ad (step 106 in FIG. 1). One or more steps in the process 200 can be carried out by, for example, the electronic system.

Initially, multiple different geographic regions are identified by the system (step 202). In some implementations, the geographic regions can be defined by regions of interest, such as, for example, cities, states, zip codes, or metropolitan areas of interest. In other implementations, the geographic regions can be defined by the distribution regions of publications of interest. For example, if a publication is distributed in one particular metropolitan area, then the geographic region is defined as that particular metropolitan area. The metropolitan area may include multiple cities, regions from multiple states, and/or multiple zip codes.

Publications distributed in the multiple different geographic regions can also be identified by the system. In some implementations, all of the known publications that are distributed in the geographic regions are identified. For example, if the zip code of 20854 is identified as a geographic region, all of the known publications that are distributed in the zip code of 20854 are identified. In other implementations, only a predetermined number of publications having the highest circulation in each geographic region are identified. In yet other implementations, only publications having circulation greater than a predetermined threshold in each geographic region are identified. In other implementations, only publications distributed by a particular publisher of interest in each geographic region are identified.

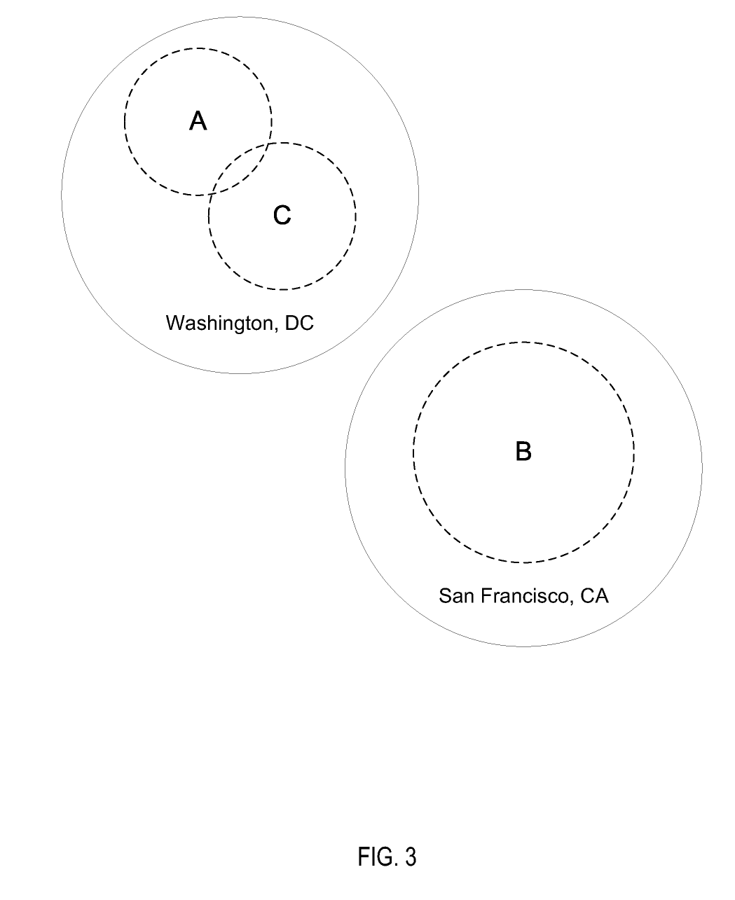

For example, FIG. 3 shows two identified publications A and C that are distributed in the Washington, D.C. metropolitan area and a third identified publication B that is distributed in the San Francisco metropolitan area. As shown, publications A and B are distributed in completely different geographic regions. For example, publication A is only distributed in the city of Rockville, Md. and publication B is distributed to the majority of the residents in the San Francisco metropolitan area. Therefore, the pair of publications A and B are identified as a pair of publications distributed in different geographic areas. Similarly, because the distribution regions of publications B and C are completely different, publications B and C are also identified as a pair of publications distributed in different geographic regions.

Publications A and C are not distributed in completely different geographic regions. For example, publication C is distributed in a sub region of Rockville, Md. Therefore, in some implementations, publications A and C arc not identified as a pair of publications distributed in different geographic regions. However, in other implementations, a predetermined percentage of overlap in distribution region may be tolerated. For example, if the overlap in the distribution regions of publications A and C is less than 5%, then publications A and C may be identified as a pair of publications distributed in different geographic regions.

The query volumes for one or more identified keywords in the different geographic regions are determined over a predetermined time period (step 204). The query volumes can be determined based on the received query volume information. For example, each time a search query including one of the identified keywords originates from a geographic region, the query volume for that geographic region is incremented by one.

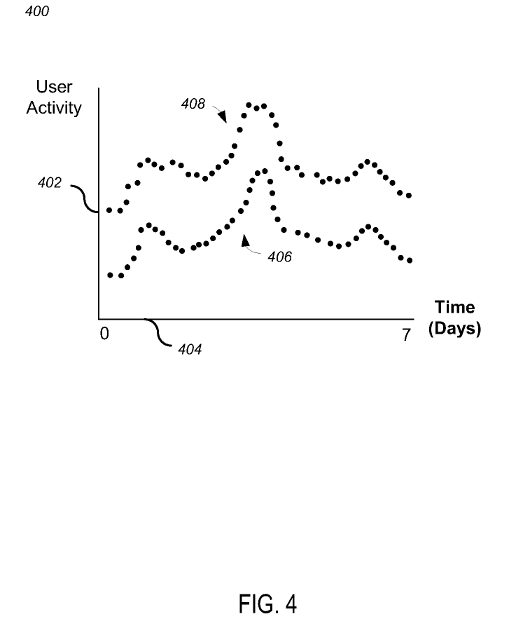

For example, FIG. 4 shows a chart 400 of query volume for one identified keyword in two different geographic regions over time. The chart 400 plots query volume on a vertical axis 402 and time on a horizontal axis 404. The query volume can be represented by the number of search queries including the identified high-valued keyword and the time can be represented by the number of days, e.g., 7 days. The number of days can represent the number of days before the print ad will be placed in a selected publication.

Data points 406 show the query volume for a first geographic region and data points 408 show the query volume for a second geographic region. The mean and standard deviation of each set of data points 406 and 408 can be calculated. In addition, the mean ratio of the data points 406 and 408, the standard deviation of the ratio of the data points 406 and 408, and the correlation between the data points 406 and 408 can be calculated. For example, as shown in FIG. 4, the mean of the data points 408 is greater than the mean of the data points 406, and the correlation between the data points 406 and 408 is relatively high (for example, greater than 0.9). Similar calculations can be made for the query volumes of the other pairs of geographic regions.

Each identified pair of geographic regions is filtered to identify an eligible pair of geographic regions (step 206). In some implementations, to be identified as an eligible pair of geographic regions, an identified pair of geographic regions must satisfy all of the thresholds described below. In other implementations, the pair of geographic regions must satisfy some subset of the thresholds and/or one or more additional thresholds.

As a first condition, the calculated mean of the query volume in each geographic region must be greater than a threshold. For example, the means of the data points 406 and 408 must each be greater than a threshold of 20. In other words, the first and second geographic regions must average more than 20 search queries including the identified high-valued keyword in order for the identified pair of geographic regions to be identified as an eligible pair of geographic regions.

As an additional condition, the calculated standard deviation of the query volume in each geographic region must be greater than a threshold. In addition, a ratio of the means and the ratio of the standard deviations for each identified pair of geographic regions must be less than another threshold. Also, the standard deviation of the ratio of the query volumes in each geographic region can be divided by the mean ratio of the query volumes in each geographic region, with the resulting value being required to be less than yet another threshold. Finally, the correlation between query volumes of a pair of identified geographic regions must be greater than a threshold.

In other implementations, an identified pair of geographic regions only has to satisfy one of the thresholds described above to be identified as an eligible pair of geographic regions. For example, if the correlation between the query volumes of an identified pair of geographic regions is greater than 0.7, the identified pair of geographic regions is identified as an eligible pair of geographic regions. In this example, because the correlation between the data points 406 and 408 is greater than 0.9, the first and second geographic regions would be identified as an eligible pair of geographic regions.

If two or more eligible pairs of geographic regions are identified, one eligible pair of geographic regions is selected (step 212). For example, the selected eligible pair of geographic regions can be the pair having the highest correlation between their query volumes. In another example, the selected eligible pair of geographic regions can be the pair having the least deviance, i.e., the lowest value calculated by dividing the standard deviation of the ratio of the query volumes of the geographic regions by the mean ratio of the query volumes, between the query volumes of its geographic regions.

In yet another example, the selected eligible pair of geographic regions can be the pair having the greatest population coverage. For example, in connection with FIG. 3, region B has greater population coverage in the San Francisco metropolitan region than region C does in the Washington, D.C. metropolitan region. Therefore, if both geographic region pairs A and B and A and C are eligible, then geographic region pair A and B would be selected, since geographic region B has a greater population coverage than geographic region C.

One publication distributed in the selected pair of eligible geographic regions is selected to place a print ad (step 210). In some implementations, the publication selected can be the publication in the geographic region with the greater mean query volume. In other implementations, the publication selected can be the publication in the geographic region with the lower standard deviation. The geographic region that is not selected to place a print ad is used as a “control” geographic region to determine whether placing the print ad increases query volume in the geographic region of the selected publication.

FIG. 5 is a flowchart showing an example process 500 for analyzing the effectiveness of a print ad (step 116 in FIG. 1). One or more steps in the process 500 can be carried out by, for example, the electronic system.

After the print ad has been published in the selected publication, the query volumes for the keyword included in the print ad in the selected pair of geographic regions are determined (step 502). Query volumes can be determined using the same methodology used to determine the query volumes for the one or more identified keywords in step 208 of FIG. 2.

Linear regression on the query volume of the control geographic region is performed to calculate a predicted query volume of the geographic region of the selected publication if the print ad had not been placed in the selected publication (step 504). For example, the determined linear regression may indicate that the control geographic region averaged 25 search queries per day including the keyword for the seven days following publication of the print ad in the selected publication. If the query volume for the geographic region of the selected publication is, on average, about 25% higher than the query volume for the geographic region of the control publication, then it is predicted that query volume of the geographic region of the selected publication would have been 31 search queries per day during the same time period if the print ad had not been placed.

In some implementations, the predicted query volume of the geographic region of the selected publication can be additionally adjusted based on correlation between the query volumes of the selected and control geographic regions. For example, the higher the correlation between the query volumes of the selected and control geographic regions, the less the predicted query volume will be adjusted. In other implementations, the predicted query volume of the geographic region of the selected publication can be additionally adjusted based on deviance between the query volumes of the selected and control geographic regions. For example, the lower the deviance between the query volumes of the selected and control geographic regions, the less the predicted query volume will be adjusted.

Once the query volume of the selected geographic region has been predicted, the predicted query volume is compared to the actual query volume of the selected geographic region (step 506). The comparison is performed to determine whether the print ad resulted in additional query volume for the keyword included in the print ad. For example, it can be determined that the geographic region of the selected publication averaged 49 search queries per day including the keyword for the seven days following publication of the print ad. As such, 18 additional search queries (the 49 actual queries less the 31 predicted queries) may have resulted from the publication of the print ad. In some implementations, if the additional query volume is greater than two times the standard deviation calculated for the query volume of the geographic region of the selected publication, the additional query volume is determine to be significant.

The determined additional query volume for the geographic region of the selected publication is used to determine additional revenue generated by placement of the print ad in the selected publication (step 508). In some implementations, if the click-through rate is assumed to be constant, the revenue generated by the print ad is calculated by multiplying the additional query volume by the click-through rate by the amount paid by an advertiser when an ad is selected. In other implementations, if the click-through rate is assumed to be constant, the revenue generated by the print ad is calculated by multiplying the additional query volume by the revenue per predetermined number of impressions, i.e., revenue per thousand impressions (RPM). In yet other implementations, the revenue generated by the print ad is calculated by subtracting a projected revenue for an advertiser and/or product from the actual revenue for the advertiser and/or product.

The additional revenue generated by placement of the print ad in the selected publication is compared with the cost of placing the print ad to determine if profit is generated by the print ad (step 510). FIG. 6 shows an example print ad placed in the selected publication. As shown in FIG. 6, the content is an article 602 published in a newspaper regarding the topic of cholesterol. The article 602 includes text 603 and can also include images. The generated print ad 604 is placed inline with the article, so that the reader of the article recognizes that the print ad is related to the article. The print ad 604 includes text encouraging the reader to search for a keyword, e.g., cholesterol. Below the text, the identified high-valued keyword is shown within a search box. Below the search box, related keywords, e.g., heart disease, medical insurance, and smoking, are shown. As described above, these related keywords may or may not match the identified high-valued keywords.

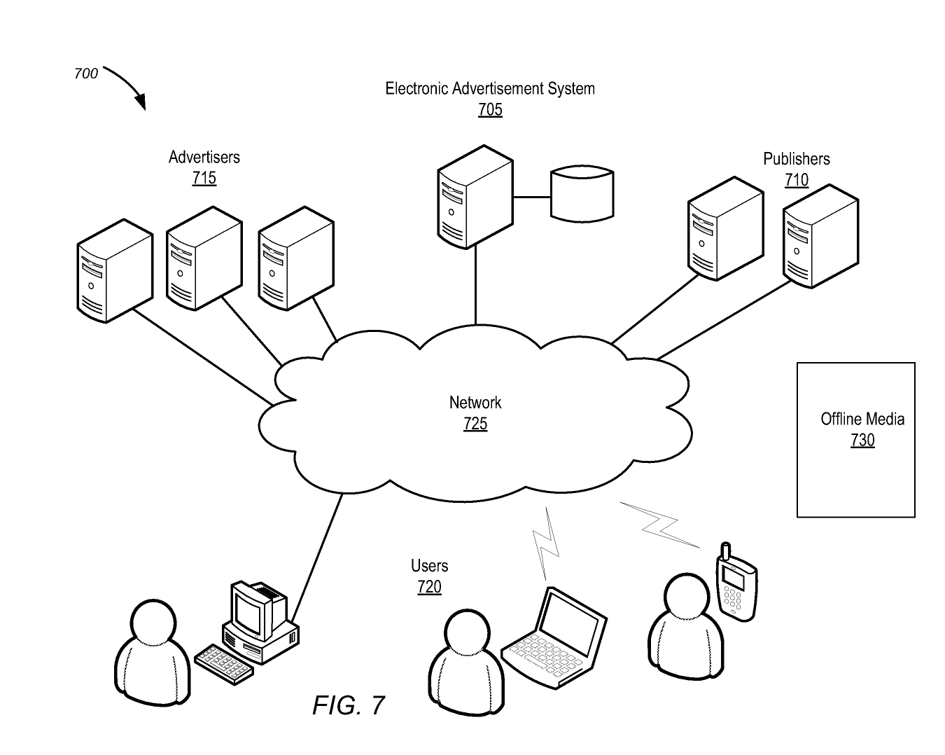

FIG. 7 is a block diagram of an example advertising system 700. The advertising system 700 includes advertisers 715, the electronic advertisement system 705, publishers 710, and users 720. A publisher 710 is an entity that publishes content (e.g., print ads) or places content (e.g., print ads) for publication with another entity. An advertiser 715 is an entity that desires to place a print ad in a printed publication. The advertiser 715 can be a direct (e.g., an advertising entity) or indirect supplier (e.g., a middle man) of the print ad. In some implementations, the advertiser 715 and one or more of the publishers 710 may have a specified relationship, such as a previous advertising relationship.

The system further includes an electronic advertisement system 705. The electronic advertisement system 705 operates to bring the advertisers 715 and publishers 710 together. Each of these entities can be coupled to a network 725 (e.g., the Internet) using one or more communication channels (e.g., wireless, optical, Ethernet). The advertising system 705 also includes offline media 730, such as, for example, print media, television media, and radio media. The advertisements within offline media 730 can be monitored by the electronic advertisement system 705.

The functional operations described can be implemented in digital electronic circuitry, or in computer hardware, firmware, software, or in combinations of them. The electronic advertisement system 705 can be implemented in a computer program product tangibly embodied in a machine-readable storage device for execution by a programmable processor. The steps performed by the electronic advertisement system 705 can be performed by a programmable processor executing a program of instructions to perform functions of the invention by operating on input data and generating output.

The electronic advertisement system 705 can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the electronic advertisement system 705 can be implemented on a computer system having a display device such as a monitor or LCD screen for displaying information to the user and a keyboard and a pointing device such as a mouse or a trackball by which the user can provide input to the computer system. The computer system can be programmed to provide a GUI through which computer programs interact with users.

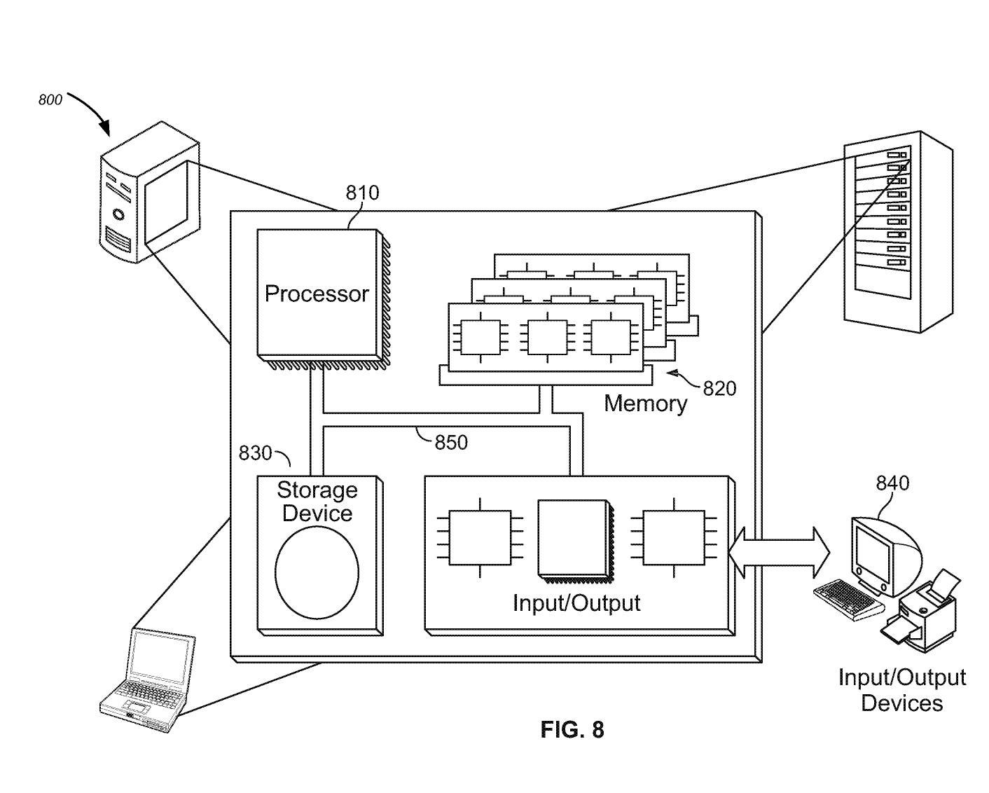

FIG. 8 shows a schematic diagram of an example computer system 800 that can be used to implement a server hosting the electronic advertisement system 705, the advertisers 715 and/or the publishers 710.

The system 800 includes a processor 810, a memory 820, a storage device 830, and an input/output device 840. Each of the components 810, 820, 830, and 840 can, for example, be interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840. In some embodiments, a parallel processing set of systems 800 connected over a network may be employed, clustered into one or more server centers.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can, for example, include a hard disk device, an optical disk device, or some other large capacity storage device.

The input/output device 840 provides input/output operations for the system 800. In one implementation, the input/output device 840 includes a keyboard and/or pointing device. In another implementation, the input/output device 840 includes a display unit for displaying GUIs.

A module can be a piece of hardware that encapsulates a function, can be firmware or can be a software application. A module can perform one or more functions, and one piece of hardware, firmware or software can perform the functions of more than one of the modules described herein. Similarly, more than one piece of hardware, firmware and/or software can be used to perform the function of a single module described herein.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a publisher” includes two or more publishers and reference to “an ad” includes a combination of two or more different types of ads.

A number of implementations have been described. Nevertheless, it will be understood that various modifications may be made without departing from the spirit and scope of the claims.

In some implementations, the different geographic regions identified in step 202 can be only distribution regions of different publications. For example, with reference to FIG. 3, geographic regions A, B, and C can be selected, as they each correspond to distribution regions of different publications. However, the entire San Francisco geographic region could not be selected in this implementation if no publication is distributed to an entirety of the San Francisco geographic region. In some implementations, the print ad generated in step 112 can include search results that can be found by searching for the one or more of the identified keywords using a search engine. A number, such as five, of the most relevant search results can be included in the print ad. For example, the search results can be included adjacent to the search box including the one or more of the identified keywords. In another example, the search box may not be included if the search results are included in the print ad.

In one example, the text of the search results in the print ad may be similar to the text presented by a search engine. In this example, one or more of a title of each search result, a portion of the relevant content included in each search result, and a Uniform Resource Locator (“URL”) for each search result can be included in the print ad. In another example, other information, such as a synopsis of each search result, can be included in the print ad. The type of information included for each search result does not have to be the same. For example, the first and/or most relevant search result may be presented with a title and a synopsis, whereas the other search results may only include a title.

In some implementations, the search results for the one or more of the identified keywords that can be included in the print ad may be websites found from all categories of websites. In other implementations, the search results may be limited to a particular category. For example, the search results can be limited to news stories related to the one or more of the identified keywords. In another example, the search results can be limited to products related to the one or more of the identified keywords. In yet another example, the search results can be limited to websites on a particular domain related to the one or more of the identified keywords.

In other implementations, after the print ad has been published, the query volumes determined in step 502 of FIG. 5 can be filtered to determine whether the selected eligible pair of geographic regions continues to satisfy the thresholds described in connection with step 210 of FIG. 2. By filtering after the print ad has been published, confidence in the predicted query volume can be increased.

In some implementations, placements of print ads that fail to generate a profit may be analyzed to determine a systemic property of failed print ads. For example, the system may determine that if print ads are placed in a publication distributed to a particular geographic region, the print ads never generate a profit. In response, the geographic region may be removed as a potential geographic region for placing print ads, In another example, the system may determine that keywords of a particular category, such as cooking keywords, systemically fail to generate a profit. In response, the cooking keywords may not be identified as potential profit opportunities.

In some implementations, the time over which the query volume is determined may be consecutive days. In other implementations, the time may be only particular days of the week. For example, if the print ad is published in only the Sunday edition of a newspaper, the query volume is determined for seven consecutive Sundays, rather than one week, i.e., seven consecutive days.

Accordingly, other implementations are within the scope of this application.

What is claimed is:

1. A method comprising:
receiving a keyword;
receiving first online query volume information for the keyword in a first geographic region;
receiving second online query volume information for the keyword in a second geographic region, the second geographic region being different from the first geographic region;
calculating a first parameter based on the first online query volume information and the second online query volume information;
determining that the first parameter satisfies a threshold;
identifying, in response to the determination that the first parameter satisfies the threshold, a first medium distributed in the first geographic region;
forwarding an item including the keyword for placement in the first medium; and
determining revenue generated by placement of the item in the first medium.

2. The method of claim 1, wherein the item is an advertisement.

3. The method of claim 1, wherein receiving the keyword comprises determining whether revenue generated by the keyword for a particular number of impressions is greater than a predetermined threshold.

4. The method of claim 1, wherein:
receiving the first online query volume information for the keyword in the first geographic region comprises receiving a first number of times the keyword was included in online search queries originating from the first geographic region; and
receiving the second online query volume information for the keyword in the second geographic region comprises receiving a second number of times the keyword was included in online search queries originating from the second geographic region.

5. The method of claim 4, further comprising:
determining that the first number of times the keyword was included in online search queries originating from the first geographic region satisfies a predetermined threshold; and
determining that the second number of times the keyword was included in online search queries originating from the second geographic region satisfies the predetermined threshold.

6. The method of claim 4, wherein calculating the first parameter based on the first online query volume information and the second online query volume information comprises determining a correlation coefficient between the first number of times the keyword was included in online search queries originating from the first geographic region and the second number of times the keyword was included in online search queries originating from the second geographic region.

7. The method of claim 1, wherein determining the revenue generated by placement of the item in the first medium comprises:
determining an actual number of online search queries including the keyword originating from the first geographic region over a predetermined time period after the item has been placed in the first medium;
determining an actual number of online search queries including the keyword originating from the second geographic region over the predetermined time period after the item has been placed in the first medium;
determining, based on the actual number of online search queries including the keyword originating from the second geographic region, a predicted number of online search queries including the keyword originating from the first geographic region over the predetermined time period if the item had not been placed in the first medium;
calculating the difference between the actual number and the predicted number of online search queries including the keyword originating from the first geographic region to determine an additional number of online search queries; and
determining, based on the additional number of online search queries, the revenue generated by placement of the item in the first medium.

8. The method of claim 7, wherein determining, based on the additional number of online search queries, the revenue generated by placement of the item in the first medium comprises:
receiving an average amount of revenue generated by the keyword for a particular number of impressions; and
multiplying the additional number of online search queries by the average amount of revenue generated by the keyword for a particular number of impressions.

9. The method of claim 1, further comprising:
determining a cost associated with placement of the item in the first medium;
determining that the revenue generated by placement of the item in the first medium is greater than the cost associated with placement of the item in the first medium; and
determining, based on the determination that the revenue generated by placement of the item in the first medium is greater than the cost associated with placement of the item in the first medium, that the item placement was effective.

10. The method of claim 1, further comprising identifying one or more additional keywords, wherein:
forwarding the item including the keyword for placement in the first medium comprises forwarding an item including the keyword and the one or more additional keywords for placement in the first medium.

11. The method of claim 1, wherein the first geographic region and the second geographic region overlap by less than a predetermined threshold.

12. The method of claim 1, wherein forwarding the item including the keyword for placement in the first medium comprises generating the item including the keyword using existing online information.

13. A system comprising at least one processor connected to at least one storage device, wherein the at least one processor is configured to:
receive a keyword;
receive first online query volume information for the keyword in a first geographic region;
receive second online query volume information for the keyword in a second geographic region, the second geographic region being different from the first geographic region;
calculate a first parameter based on the first online query volume information and the second online query volume information;
determine that the first parameter satisfies a threshold;
identify, in response to the determination that the first parameter satisfies the threshold, a first medium distributed in the first geographic region;
forward an item including the keyword for placement in the first medium; and
determine revenue generated by placement of the item in the first medium.

14. The system of claim 13, wherein the at least one processor is configured to receive the keyword by determining whether revenue generated by the keyword for a particular number of impressions is greater than a predetermined threshold.

15. The system of claim 13, wherein the at least one processor is configured to:
receive the first online query volume information for the keyword in the first geographic region by receiving a first number of times the keyword was included in online search queries originating from the first geographic region; and
receive the second online query volume information for the keyword in the second geographic region by receiving a second number of times the keyword was included in online search queries originating from the second geographic region.

16. The system of claim 13, wherein the at least one processor is configured to determine the revenue generated by placement of the item in the first medium by:
determining an actual number of online search queries including the keyword originating from the first geographic region over a predetermined time period after the item has been placed in the first medium;
determining an actual number of online search queries including the keyword originating from the second geographic region over the predetermined time period after the item has been placed in the first medium;
determining, based on the actual number of online search queries including the keyword originating from the second geographic region, a predicted number of online search queries including the keyword originating from the first geographic region over the predetermined time period if the item had not been placed in the first medium;
calculating the difference between the actual number and the predicted number of online search queries including the keyword originating from the first geographic region to determine an additional number of online search queries; and determining, based on the additional number of online search queries, the revenue generated by placement of the item in the first medium.

17. A storage device storing a computer program, the computer program comprising one or more code segments that, when executed, cause at least one processor to:
receive a keyword;
receive first online query volume information for the keyword in a first geographic region;
receive second online query volume information for the keyword in a second geographic region, the second geographic region being different from the first geographic region;
calculate a first parameter based on the first online query volume information and the second online query volume information;
determine that the first parameter satisfies a threshold;
identify, in response to the determination that the first parameter satisfies the threshold, a first medium distributed in the first geographic region;
forward an item including the keyword for placement in the first medium; and
determine revenue generated by placement of the item in the first medium.

18. The storage device of claim 17, wherein the one or more code segments that, when executed, cause the at least one processor to receive the keyword comprise one or more code segments that, when executed, cause the at least one processor to determine whether revenue generated by the keyword for a particular number of impressions is greater than a predetermined threshold.

19. The storage device of claim 17, wherein the one or more code segments that, when executed, cause the at least one processor to:
receive the first online query volume information for the keyword in the first geographic region comprise one or more code segments that, when executed, cause the at least one processor to receive a first number of times the keyword was included in online search queries originating from the first geographic region; and
receive the second online query volume information for the keyword in the second geographic region comprise one or more code segments that, when executed, cause the at least one processor to receive a second number of times the keyword was included in online search queries originating from the second geographic region.

20. The storage device of claim 17, wherein the one or more code segments that, when executed, cause the at least one processor to determine the revenue generated by placement of the item in the first medium comprise one or more code segments that, when executed, cause the at least one processor to:
determine an actual number of online search queries including the keyword originating from the first geographic region over a predetermined time period after the item has been placed in the first medium;
determine an actual number of online search queries including the keyword originating from the second geographic region over the predetermined time period after the item has been placed in the first medium;
determine, based on the actual number of online search queries including the keyword originating from the second geographic region, a predicted number of online search queries including the keyword originating from the first geographic region over the predetermined time period if the item had not been placed in the first medium;
calculate the difference between the actual number and the predicted number of online search queries including the keyword originating from the first geographic region to determine an additional number of online search queries; and
determine, based on the additional number of online search queries, the revenue generated by placement of the item in the first medium.
